(19) United States
(12) Patent Application Publication
(10) Pub. No.: US 2024/0262705 A1
(43) Pub. Date: Aug. 8, 2024

(54) CERIA PARTICLES AND METHOD FOR PRODUCING THE SAME

(71) Applicant: DIC Corporation, Tokyo (JP)

(72) Inventors: Shaowei YANG, Qingdao, Shandong (CN); Takanori WATANABE, Chiba (JP); Jianjun YUAN, Chiba (JP); Wei ZHAO, Qingdao, Shandong (CN); Jian GUO, Qingdao, Shandong (CN)

(73) Assignee: DIC Corporation, Tokyo (JP)

(21) Appl. No.: 18/567,006

(22) PCT Filed: Jun. 11, 2021
(86) PCT No.: PCT/CN2021/099886

§ 371 Date: Dec. 4, 2023

(51) Int. Cl. C01F 17/32

(52) U.S. Cl. CPC C01F 17/32; C01P 2002/60; C01P 2002/72; C01P 2002/85; C01P 2004/03; C01P 2004/61; C01P 2006/80

(57) ABSTRACT

Ceria particles contain molybdenum. In the ceria particles, the molybdenum may be unevenly distributed in a surface layer of the ceria particles. A crystallite diameter of a [100] plane of the ceria particles may be 250 nm or more. A crystallite diameter of a [101] plane of the ceria particles may be 300 nm or more. A median diameter D₅₀ of the ceria particles calculated by a laser diffraction/scattering method may be 5.00 μm or more and 1000.00 μm or less. A method for producing the ceria particles includes calcining a cerium compound in presence of a molybdenum compound. The molybdenum compound may be at least one compound selected from a group including molybdenum trioxide, lithium molybdate, potassium molybdate and sodium molybdate. In the method for producing the ceria particles, a calcination temperature may be 800° C. or higher and 1600° C. or lower.

### TECHNICAL FIELD

The present invention relates to ceria particles and a method for producing the ceria particles.

### BACKGROUND

Regarding cerium oxide (that is, ceria), it is known that valence of cerium in ceria changes depending on partial pressure of oxygen in an atmosphere, ceria has optimum hardness for polishing glass, silicon, or the like, and ceria has a very large oxygen diffusion coefficient when a divalent or trivalent metal oxide is solid-dissolved. Due to these properties, the ceria is expected to be applied to solid electrolytes used in fuel cells, oxygen pumps, oxygen sensors, or the like, in addition to catalyst carriers and abrasives, and there is a need to control a particle size of ceria powders suitable for such an application.

For example, PTL 1 discloses a method for producing nanoceria powders in which an organic solvent dissolving 0.01 to 1 mol/L of cerium acid salt and having a water content of 8% by weight or less is mixed with an organic solvent dissolving 0.1 mol/L or more of an organic base agent and having a water content of 8% by weight or less, a precipitate is formed in which at least one of primary particles of cerium hydroxide or hydrated ceria are individually separated, and the precipitate is separated from a liquid phase, dried and then calcined to produce nanoceria powders having an average particle size of 100 nm or less with little or no aggregation.

### CITATION LIST

### Patent Literature

PTL 1: JP-A-2002-201023

### SUMMARY

### Technical Problem

However, knowledge about conventional ceria particles and a method for producing the ceria particles is limited, and there is still room for study.

The present invention has been made in view of the above circumstances, and provides the ceria particles having a controlled particle diameter and particle size distribution, and a method for producing the ceria particles.

### Solution to Problem

That is, the present invention includes the following aspects.

(1) Ceria particles containing molybdenum.

(2) The ceria particles according to (1) above, in which the molybdenum is unevenly distributed in a surface layer of the ceria particles.

(3) The ceria particles according to (1) or (2) above, in which a crystallite diameter of a [100] plane of the ceria particles is 250 nm or more.

(4) The ceria particles according to any one of (1) to (3) above, in which a crystallite diameter of a [101] plane of the ceria particles is 300 nm or more.

(5) The ceria particles according to any one of (1) to (4) above, in which a median diameter D₅₀ of the ceria particles calculated by a laser diffraction/scattering method is 5.00 μm or more and 1000.00 μm or less.

(6) The ceria particles according to any one of (1) to (5) above, in which
CeO₂ content C₁ with respect to 100 mass % of the ceria particles determined by XRF analysis of the ceria particles is 60.00 mass % or more and 99.30 mass % or less, and
MoO₃ content M₁ with respect to 100 mass % of the ceria particles determined by XRF analysis of the ceria particles is 0.05 mass % or more and 40.00 mass % or less.

(7) The ceria particles according to any one of (1) to (6) above, in which
CeO₂ content C₂ with respect to 100 mass % of a surface layer of the ceria particles determined by XPS surface analysis of the ceria particles is 10.00 mass % or more and 90.00 mass % or less, and
MoO₃ content M₂ with respect to 100 mass % of the surface layer of the ceria particles determined by XPS surface analysis of the ceria particles is 2.00 mass % or more and 70.00 mass % or less.

(8) The ceria particles according to any one of (1) to (7) above, in which a surface layer uneven distribution ratio M₂/M₁ of MoO₃ content M₂ with respect to 100 mass % of a surface layer of the ceria particles determined by XPS surface analysis of the ceria particles to MoO₃ content M₁ with respect to 100 mass % of the ceria particles determined by XRF analysis of the ceria particles is 0.05 or more and 1400.00 or less.

(9) A method for producing the ceria particles according to any one of (1) to (8) above, including calcining a cerium compound in presence of a molybdenum compound.

(10) The method for producing the ceria particles according to (9) above, in which the molybdenum compound is at least one compound selected from a group including molybdenum trioxide, lithium molybdate, potassium molybdate and sodium molybdate.

(11) The method for producing the ceria particles according to (9) or (10) above, in which a calcination temperature is 800° C. or higher and 1600° C. or lower.

### Advantageous Effects of Invention

According to the ceria particles of the above aspects and the method for producing the ceria particles, the ceria particles having a controlled particle diameter and particle size distribution can be obtained.

### BRIEF DESCRIPTION OF DRAWINGS

FIG. 1 is a scanning electron microscope (SEM) image of ceria particles of Example 1. A scale bar is 5.00 μm.

FIG. 2 is an SEM image of the ceria particles of Example 2. The scale bar is 5.00 μm.

FIG. 3 is an SEM image of the ceria particles of Comparative Example 1. The scale bar is 5.00 μm.

FIG. 4 is a graph illustrating measurement results of the ceria particles of Examples and Comparative Examples by an X-ray diffraction method (XRD method).

### DESCRIPTION OF EMBODIMENTS

Hereinafter, an embodiment of ceria particles and a method for producing the ceria particles of the present invention will be described.

### <<Ceria Particles>>

The ceria particles of the embodiment contain molybdenum. The ceria particles of the embodiment contain molybdenum and have excellent properties such as catalytic activity derived from molybdenum.

In the ceria particles of the embodiment, the molybdenum is preferably unevenly distributed in a surface layer of the ceria particles.

Here, the “surface layer” in this specification means within 10 nm from a surface of the ceria particles of the embodiment. This distance corresponds to a detection depth of XPS used for measurement in Examples.

Here, “unevenly distributed in the surface layer” means that a mass of molybdenum or the molybdenum compound per unit volume in the surface layer is greater than that of molybdenum or the molybdenum compound per unit volume in other than the surface layer.

In the ceria particles of the embodiment, the fact that molybdenum is unevenly distributed in the surface layer of the ceria particles is confirmed by the fact that MoO₃ content (M₂) with respect to 100 mass % of the surface layer of the ceria particles determined by XPS surface analysis of the ceria particles is greater than MoO₃ content (M₁) with respect to 100 mass % of the ceria particles determined by XRF (fluorescent X-ray) analysis of the ceria particles as described in Examples described below.

In the ceria particles of the embodiment, as an index that molybdenum is unevenly distributed in the surface layer of the ceria particles, a surface layer uneven distribution ratio (M₂/M₁) of the MoO₃ content (M₂) to the MoO₃ content (M₁) of the ceria particles of the embodiment is preferably 0.05 or more and 1400.00 or less, more preferably 1.00 or more and 700.00 or less, even more preferably 20.00 or more and 500.00 or less, and particularly preferably 25.00 or more and 400.00 or less.

By unevenly distributing molybdenum or the molybdenum compound in the surface layer, excellent properties such as catalytic activity can be efficiently imparted as compared with a case where molybdenum or the molybdenum compound is uniformly present not only in the surface layer but also in other than the surface layer (inner layer).

The ceria particles of the embodiment produced by a production method of the embodiment can have a unique granular (spherical) shape or polyhedral shape as described in Examples described below.

Note that, in this specification, “polyhedral shape” means hexahedron or more, preferably octahedron or more and triacontahedron or less. Further, since the ceria particles of the embodiment have a polyhedral shape formed by the following flux method, they form a single crystal structure.

In the ceria particles of the embodiment, a particle size and molybdenum content of ceria particles obtained can be controlled by controlling a used amount and type of the molybdenum compound in the production method described below.

In the ceria particles of the embodiment, a crystallite diameter of a [100] plane is preferably 250 nm or more, more preferably 255 nm or more, even more preferably 260 nm or more, and particularly preferably 265 nm or more. In the ceria particles of the embodiment, the crystallite diameter of the [100] plane may be 1000 nm or less, 500 nm or less, or 300 nm or less.

In this specification, as the crystallite diameter of the [100] plane of the ceria particles, a value of the crystallite diameter calculated by using Scherrer equation from a half width of a peak (that is, a peak appearing near 2θ=28.5°) attributed to the [100] plane measured by an X-ray diffraction method (XRD method) shall be adopted.

In the ceria particles of the embodiment, a crystallite diameter of a [101] plane is preferably 300 nm or more, more preferably 310 nm or more, even more preferably 330 nm or more, and particularly preferably 410 nm or more. In the ceria particles of the embodiment, the crystallite diameter of the [101] plane may be 1000 nm or less, 700 nm or less, or 500 nm or less.

In this specification, as the crystallite diameter of the [101] plane of the ceria particles, a value of the crystallite diameter calculated by using the Scherrer equation from a half width of a peak (that is, a peak appearing near 2θ=47.5°) attributed to the [101] plane measured by the X-ray diffraction method (XRD method) shall be adopted.

As an example of the ceria particles of the embodiment, the ceria particles having a crystallite diameter of the [100] plane of 250 nm or more and a crystallite diameter of the [101] plane of 300 nm or more can be exemplified. The ceria particles can be more crystalline.

A median diameter D₅₀ of the ceria particles of the embodiment calculated by a laser diffraction/scattering method is preferably 5.00 μm or more and 1000.00 μm or less, more preferably 6.00 μm or more and 100.00 μm or less, even more preferably 8.00 μm or more and 50.00 μm or less, and particularly preferably 12.00 μm or more and 30.00 μm or less.

The median diameter D₅₀ of the ceria particles calculated by the laser diffraction/scattering method can be determined as a particle diameter in which a ratio of cumulative volume % is 50% in a particle diameter distribution measured by a dry method using a laser diffraction type particle size distribution meter.

A particle diameter D₁₀ of the ceria particles of the embodiment calculated by the laser diffraction/scattering method is preferably 1.60 μm or more and 100.00 μm or less, more preferably 1.80 μm or more and 50.00 μm or less, and even more preferably 2.00 μm or more and 10.00 μm or less.

The particle diameter D₁₀ of the ceria particles calculated by the laser diffraction/scattering method can be determined as a particle diameter in which the ratio of cumulative volume % from a small particle side is 10% in the particle diameter distribution measured by the dry method using the laser diffraction type particle size distribution meter.

A particle diameter D₉₀ of the ceria particles of the embodiment calculated by the laser diffraction/scattering method is preferably 9.00 μm or more and 1500.00 μm or less, more preferably 10.00 μm or more and 300.00 μm or less, and even more preferably 15.00 μm or more and 50.00 μm or less.

The particle diameter D₉₀ of the ceria particles calculated by the laser diffraction/scattering method can be determined as a particle diameter in which the ratio of cumulative volume % from the small particle side is 90% in the particle diameter distribution measured by the dry method using the laser diffraction type particle size distribution meter.

The ceria particles of the embodiment contain ceria (cerium oxide). Examples of cerium oxide that the ceria particles of the embodiment may contain include CeO₂.

Ceria content in the ceria particles can be measured by XRF analysis. In the ceria particles of the embodiment, CeO₂ content C₁ with respect to 100 mass % of the ceria particles determined by XRF analysis of the ceria particles is preferably 60.00 mass % or more and 99.30 mass % or less, more preferably 90.00 mass % or more and 99.10 mass % or less, and even more preferably 93.00 mass % or more and 99.00 mass % or less.

The ceria particles of the embodiment contain molybdenum. In the ceria particles of the embodiment, MoO₃ content M₁ with respect to 100 mass % of the ceria particles determined by XRF analysis of the ceria particles is preferably 0.05 mass % or more and 40.00 mass % or less, more preferably 0.05 mass % or more and 20.00 mass % or less, even more preferably 0.05 mass % or more and 10.00 mass % or less, and particularly preferably 0.05 mass % or more and 2.50 mass % or less.

Upper limit values and lower limit values of the CeO₂ content C₁ and the MoO₃ content M₁ exemplified above in the ceria particles of the embodiment can be freely combined. Further, numerical values of the CeO₂ content C₁ and the MoO₃ content M₁ can be freely combined.

As an example of the ceria particles of the embodiment, the ceria particles having the CeO₂ content C₁ of 60.00 mass % or more and 99.30 mass % or less, and the MoO₃ content M₁ of 0.05 mass % or more and 40.00 mass % or less can be exemplified.

The CeO₂ content C₁ and the MoO₃ content M₁ can be measured by XRF analysis, for example, using a fluorescent X-ray analyzer (PrimusIV) manufactured by Rigaku Corporation.

The ceria content contained in the surface layer of the ceria particles can be measured by X-ray photoelectron spectroscopy (XPS) surface analysis. In the ceria particles of the embodiment, CeO₂ content C₂ with respect to 100 mass % of the surface layer of the ceria particles determined by XPS surface analysis of the ceria particles is preferably 10.00 mass % or more and 90.00 mass % or less, more preferably 10.00 mass % or more and 80.00 mass % or less, and even more preferably 10.00 mass % or more and 70.00 mass % or less.

In the ceria particles of the embodiment, MoO₃ content M₂ with respect to 100 mass % of the surface layer of the ceria particles determined by XPS surface analysis of the ceria particles is preferably 2.00 mass % or more and 70.00 mass % or less, more preferably 10.00 mass % or more and 65.00 mass % or less, and even more preferably 20.00 mass % or more and 60.00 mass % or less.

Upper limit values and lower limit values of the CeO₂ content C₂ and the MoO₃ content M₂ exemplified above in the ceria particles of the embodiment can be freely combined. Further, numerical values of the CeO₂ content C₂ and the MoO₃ content M₂ can be freely combined.

As an example of the ceria particles of the embodiment, the ceria particles having the CeO₂ content C₂ of 10.00 mass % or more and 90.00 mass % or less, and the MoO₃ content M₂ of 2.00 mass % or more and 70.00 mass % or less can be exemplified.

The above CeO₂ content C₂ refers to a value determined as the content of CeO₂ with respect to 100 mass % of the surface layer of the ceria particles by obtaining an abundance ratio (atom %) for each element by XPS surface analysis of the ceria particles by X-ray photoelectron spectroscopy (XPS) and by converting the cerium content to oxide.

The above MoO₃ content M₂ refers to a value determined as the content of MoO₃ with respect to 100 mass % of the surface layer of the ceria particles by obtaining an abundance ratio (atom %) for each element by XPS surface analysis of the ceria particles by X-ray photoelectron spectroscopy (XPS) and by converting the molybdenum content to oxide.

The ceria particles of the embodiment may further contain lithium, potassium, or sodium in addition to molybdenum.

### <Method for Producing Ceria Particles>

The method for producing the ceria particles of the embodiment (hereinafter, simply referred to as the “production method of the embodiment”) includes a step of calcining a cerium compound in presence of the molybdenum compound. More specifically, the production method of the embodiment is the method for producing the ceria particles, which may include mixing the cerium compound and the molybdenum compound to form a mixture, and calcining the mixture.

According to the method for producing the ceria particles of the embodiment, the ceria particles of the embodiment described above can be produced.

A preferred method for producing the ceria particles includes a step (mixing step) of mixing the cerium compound and the molybdenum compound to form the mixture, and a step (calcination step) of calcining the mixture.

### [Mixing Step]

The mixing step is a step of mixing the cerium compound and the molybdenum compound to form the mixture. The contents of the mixture will be described below.

### (Cerium Compound)

The cerium compound is not limited as long as it is a compound that can be calcined to the cerium oxide. Examples of the cerium compound include the cerium oxide, cerium hydroxide, cerium oxalate and the like, and the cerium oxide is preferable. The cerium oxide may be Ce₂O₃ (cerium oxide (III)), CeO₂ (cerium oxide (IV)), or cerium oxide including Ce₂O₃ and CeO₂.

Since a shape of the ceria particles after calcination hardly reflects a shape of a raw material cerium compound, any shape such as a sphere, an amorphous shape, a structure having an aspect (a wire, a fiber, a ribbon, a tube, or the like), or a sheet can be suitably used as the cerium compound.

### (Molybdenum Compound)

Examples of the molybdenum compound include molybdenum oxide and molybdate compounds.

Examples of the molybdenum oxide include molybdenum dioxide and molybdenum trioxide, and the molybdenum trioxide is preferable.

The molybdate compound is not limited as long as it is a salt compound of molybdenum oxoanion such as MoO₄²⁻, Mo₂O₇²⁻, Mo₃O₁₀²⁻, Mo₄O₁₃²⁻, Mo₅O₁₆²⁻, Mo₆O₁₉²⁻, Mo₇O₂₄⁶⁻, or Mo₈O₂₆⁴⁻. It may be an alkali metal salt of the molybdenum oxoanion, an alkaline earth metal salt, or an ammonium salt.

As the molybdate compound, the alkali metal salt of the molybdenum oxoanion is preferable, lithium molybdate, potassium molybdate or sodium molybdate is more preferable, and potassium molybdate or sodium molybdate is further preferable.

In the production method of the embodiment, the molybdate compound may be a hydrate.

The molybdate compound is preferably at least one compound selected from a group including molybdenum trioxide, lithium molybdate, potassium molybdate, and sodium molybdate, and more preferably at least one compound selected from a group including molybdenum trioxide, potassium molybdate, and sodium molybdate.

The production method of the embodiment may include a step of calcining the cerium compound in the presence of the molybdenum compound and a potassium compound.

The production method of the embodiment can include the step (mixing step) of mixing the cerium compound, the molybdenum compound, and the potassium compound to form the mixture prior to the calcination step, and can include the step (calcination step) of calcining the mixture.

Alternatively, the production method of the embodiment can include the step (mixing step) of mixing the cerium compound and a compound containing molybdenum and potassium to form the mixture prior to the calcination step, and can include the step (calcination step) of calcining the mixture.

The compound containing molybdenum and potassium, which is suitable as a flux agent, can be produced, for example, using a molybdenum compound and a potassium compound, which are cheaper and more easily available, as raw materials in the calcination step. Here, both when the molybdenum compound and the potassium compound are used as the flux agent and when the compound containing molybdenum and potassium is used as the flux agent are combined and regarded as when the molybdenum compound and the potassium compound are used as the flux agent, that is, in the presence of the molybdenum compound and the potassium compound.

The production method of the embodiment may include a step of calcining the cerium compound in the presence of the molybdenum compound and a sodium compound.

The production method of the embodiment can include a step (mixing step) of mixing the cerium compound, the molybdenum compound, and the sodium compound to form the mixture prior to the calcination step, and can include a step (calcination step) of calcining the mixture.

Alternatively, the production method of the embodiment can include a step (mixing step) of mixing the cerium compound and a compound containing molybdenum and sodium to form the mixture prior to the calcination step, and can include a step (calcination step) of calcining the mixture.

The compound containing molybdenum and sodium, which is suitable as the flux agent, can be produced, for example, using the molybdenum compound and the sodium compound, which are cheaper and more easily available, as raw materials in the calcination step. Here, both when the molybdenum compound and the sodium compound are used as the flux agent and when the compound containing molybdenum and sodium is used as the flux agent are combined and regarded as when the molybdenum compound and the sodium compound are used as the flux agent, that is, in the presence of the molybdenum compound and the sodium compound.

By calcining the cerium compound in the presence of the molybdenum compound and the potassium compound, or in the presence of the molybdenum compound and the sodium compound, the ceria particles having a high molybdenum content can be easily obtained, and the particle diameter of the ceria particles produced can be easily adjusted. The reason is not clear, but the following reasons can be considered. For example, since K₂MoO₄ and Na₂MoO₄ are stable compounds and are difficult to volatilize in the calcination step, they are unlikely to be accompanied by a rapid reaction in a volatilization step, and growth of the ceria particles can be easily controlled. Further, it is considered that the molten K₂MoO₄ and Na₂MoO₄ exert a function like a solvent, and for example, by increasing a reaction time, a value of the particle diameter can be increased.

In the production method of the embodiment, the molybdenum compound is used as the flux agent. Hereinafter, in this specification, the production method using the molybdenum compound as the flux agent may be simply referred to as the “flux method”. Note that after the molybdenum compound reacts with the cerium compound at a high temperature to form cerium molybdate by such calcination, when the cerium molybdate is further decomposed into cerium and molybdenum oxide at a higher temperature, it is considered that the molybdenum compound is incorporated into the ceria particles. It is considered that the molybdenum oxide is sublimated and removed from the system, and in this step, the molybdenum compound and the cerium compound react to form the molybdenum compound in the surface layer of the ceria particles. Regarding formation mechanism of the molybdenum compound contained in the ceria particles, more specifically, it is considered that Mo—O—Ce is formed in the surface layer of the ceria particles by reaction of molybdenum and Ce atoms, Mo is desorbed by high-temperature calcination, and the molybdenum oxide, a compound having a Mo—O—Ce bond, or the like is formed in the surface layer of the ceria particles.

The molybdenum oxide that is not incorporated into the ceria particles can also be recovered by sublimation and reused. In this way, an amount of the molybdenum oxide adhering to the surface of the ceria particles can be reduced, and original properties of the ceria particles can be maximized.

On the other hand, the alkali metal salt of the molybdenum oxoanion does not vaporize even in a calcination temperature range and can be easily recovered by washing after calcination, so that an amount of the molybdenum compound released to outside a calcining furnace is also reduced, and production cost can also be significantly reduced.

In the above flux method, for example, when the molybdenum compound and the potassium compound are used in combination, it is considered that the molybdenum compound and the potassium compound first react to form the potassium molybdate. At the same time, it is considered that the molybdenum compound reacts with the cerium compound to form the cerium molybdate. Then, for example, the cerium molybdate is decomposed in the presence of potassium molybdate in a liquid phase to grow crystals, so that the ceria particles having a large particle size and a high molybdenum content can be easily obtained while suppressing evaporation of flux (sublimation of MoO₃) described above.

### (Metal Compound)

A metal compound can be used at a time of calcination if desired. The production method of the embodiment can include a step (mixing step) of mixing the cerium compound, the molybdenum compound, the potassium compound, and the metal compound to form the mixture prior to the calcination step, and can include a step (calcination step) of calcining the mixture.

The metal compound is not particularly limited, but preferably contains at least one selected from a group including Group II metal compounds and Group III metal compounds.

Examples of the Group II metal compounds include magnesium compounds, calcium compounds, strontium compounds, barium compounds and the like.

Examples of the Group III metal compounds include scandium compounds, yttrium compounds, lanthanum compounds and the like.

The above-mentioned metal compound means an oxide, a hydroxide, a carbonate, or a chloride of a metal element. For example, in the case of the yttrium compound, yttrium oxide (Y₂O₃), yttrium hydroxide, and yttrium carbonate can be mentioned. Of these, the metal compound is preferably an oxide of the metal element. Note that the metal compound contains an isomer.

Of these, the metal compound of period 3 element, the metal compound of period 4 element, the metal compound of period 5 element, and the metal compound of period 6 element are preferable, the metal compound of period 4 element and the metal compound of period 5 element are more preferable, and the metal compound of period 5 element is further preferable. Specifically, the magnesium compound, the calcium compound, the yttrium compound, and the lanthanum compound are preferably used, the magnesium compound, the calcium compound, and the yttrium compound are more preferably used, and the yttrium compound is particularly preferably used.

The metal compound is preferably used in a proportion of, for example, 0 mass % or more and 1.2 mass % or less (for example, 0 μmol % or more and 1 mol % or less) with respect to a total amount (total mass or total molar amount) of the cerium compounds used in the mixing step.

In the production method of the embodiment, blending amounts of the cerium compound and the molybdenum compound are not particularly limited, but preferably 35 mass % or more of the cerium compound and 65 mass % or less of the molybdenum compound are mixed with respect to 100 mass % of the mixture to form the mixture, and the mixture can be calcined. More preferably, 40 mass % or more and 90 mass % or less of the cerium compound and 0.5 mass % or more and 60 mass % or less of the molybdenum compound are mixed with respect to 100 mass % of the mixture to form the mixture, and the mixture can be calcined. Even more preferably, 42 mass % or more and 50 mass % or less of the cerium compound and 38 mass % or more and 50 mass % or less of the molybdenum compound are mixed with respect to 100 mass % of the mixture to form the mixture, and the mixture can be calcined.

In the production method of the embodiment, a value of a molar ratio (molybdenum/cerium) of molybdenum atom in the molybdenum compound and cerium atom in the cerium compound is preferably 0.01 or more, more preferably 0.10 or more, even more preferably 0.30 or more, and particularly preferably 0.50 or more.

An upper limit value of the molar ratio of the molybdenum atom in the molybdenum compound and the cerium atom in the cerium compound may be appropriately determined, but from a viewpoint of reducing the amount of molybdenum compound used and improving production efficiency, for example, the value of the above molar ratio (molybdenum/cerium) may be 5.00 or less, 4.00 or less, 3.00 or less, or 1.50 or less.

As an example of a numerical range of the molar ratio (molybdenum/cerium), for example, the value of molybdenum/cerium may be 0.01 or more and 5.00 or less, 0.10 or more and 4.00 or less, 0.30 or more and 3.00 or less, and 0.50 or more and 1.50 or less.

It should be noted that as the amount of molybdenum used with respect to the cerium is increased, the ceria particles having a large particle size shown in the above particle size distribution tend to be obtained.

By using various compounds in the above range, the amount of the molybdenum compound contained in the ceria particles obtained becomes more appropriate, and the ceria particles having a controlled particle size can be easily obtained.

### [Calcination Step]

The calcination step is a step of calcining the mixture. The ceria particles according to the embodiment can be obtained by calcining the mixture. As described above, the production method is called the flux method.

The flux method is classified as a solution method. More specifically, the flux method is a method of crystal growth utilizing the fact that a crystal-flux two-component phase diagram shows a eutectic type. A mechanism of the flux method is presumed to be as follows. That is, when a mixture of solute and the flux is heated, the solute and the flux become a liquid phase. At this time, since the flux is a fusing agent, in other words, since a solute-flux two-component phase diagram shows a eutectic type, the solute melts at a temperature lower than its melting point to form the liquid phase. If the flux is evaporated in this state, concentration of the flux is reduced, in other words, an effect on lowering the melting point of the solute by the flux is reduced, and the evaporation of the flux acts as a driving force to cause crystal growth of the solute (flux evaporation method). Note that the solute and the flux can also cause the crystal growth of the solute by cooling the liquid phase (slow cooling method).

The flux method has merits such as being able to grow the crystals at a temperature much lower than the melting point, being able to precisely control a crystal structure, and being able to form a polyhedral crystal having an automorphic shape.

In production of the ceria particles by the flux method using the molybdenum compound as the flux, the mechanism is not always clear, but for example, it is presumed that the mechanism is as follows. That is, when the cerium compound is calcined in the presence of the molybdenum compound, the cerium molybdate is first formed. At this time, as can be understood from the above description, the cerium molybdate grows ceria crystals at a temperature lower than the melting point of the ceria. Then, for example, by evaporating the flux, the cerium molybdate is decomposed to grow the crystals, so that the ceria particles can be obtained. That is, the molybdenum compound functions as the flux, and the ceria particles are produced via an intermediate called the cerium molybdate.

By the above flux method, the ceria particles containing molybdenum and in which the molybdenum is unevenly distributed in the surface layer of the ceria particles can be produced.

A method of calcination is not particularly limited, and the calcination can be performed by a known and commonly used method. When the calcination temperature exceeds 800° C., it is considered that the cerium compound and the molybdenum compound react to form the cerium molybdate. Further, it is considered that when the calcination temperature becomes 950° C. or higher, the cerium molybdate is decomposed to form the ceria particles. Further, in the ceria particles, it is considered that the molybdenum compound is incorporated into the ceria particles when the cerium molybdate is decomposed into the ceria and the molybdenum oxide.

Further, a state of the cerium compound and the molybdenum compound at the time of calcination is not particularly limited, and the molybdenum compound may be present in the same space where the molybdenum compound can act on the cerium compound. Specifically, the state may be simple mixing in which powders of the molybdenum compound and powders of the cerium compound are mixed, mechanical mixing using a crusher or the like, a mixture using a mortar or the like, and may be mixing in a dry state or in a wet state.

Conditions of the calcination temperature are not particularly limited, and are appropriately determined in consideration of a target particle size of the ceria particles, formation of the molybdenum compound in the ceria particles, the shape of the ceria particles, and the like. The calcination temperature may be 900° C. or higher, which is close to a decomposition temperature of the cerium molybdate, 950° C. or higher, or 1000° C. or higher.

As the calcination temperature is higher, the ceria particles having a controlled particle shape and a large particle size tend to be easily obtained. From a viewpoint of efficiently producing such ceria particles, the calcination temperature is preferably 950° C. or higher, more preferably 1000° C. or higher, even more preferably 1100° C. or higher, and particularly preferably 1200° C. or higher.

Generally, when trying to control the shape of the ceria particles obtained after calcination, it is necessary to perform the high-temperature calcination at a temperature of over 2400° C., which is close to the melting point of the ceria, but there is a big problem in industrial applications from viewpoints of load on the calcining furnace and fuel cost.

According to the embodiment of the present invention, for example, even if the condition is that the maximum calcination temperature for calcining the cerium compound is 1600° C. or lower, the ceria particles can be efficiently formed at low cost.

Further, according to the production method of the embodiment, even if the calcination temperature is 1600° C. or lower, which is much lower than the melting point of the ceria, the ceria particles having an automorphic shape can be formed regardless of a shape of a precursor. From this point of view, the calcination temperature is preferably 1500° C. or lower, more preferably 1400° C. or lower, and even more preferably 1300° C. or lower.

As an example, a numerical range of the calcination temperature at which the cerium compound is calcined in the calcination step may be 900° C. or higher and 1600° C. or lower, 900° C. or higher and 1500° C. or lower, 950° C. or higher and 1400° C. or lower, 1000° C. or higher and 1300° C. or lower, or 1100° C. or higher and 1300° C. or lower.

From a viewpoint of the production efficiency, a heating rate may be 20° C./hour or more and 600° C./hour or less, 40° C./hour or more and 500° C./hour or less, and 80° C./hour or more and 400° C./hour or less.

Regarding a calcination time, the calcination is preferably performed such that a raising time to a predetermined calcination temperature is in a range of 15 minutes or more and 10 hours or less, and a holding time at the calcination temperature is in a range of 5 minutes or more and 30 hours or less. In order to efficiently form the ceria particles, it is more preferred that the holding time at the calcination temperature is 2 hours or more and 24 hours or less.

As an example, by selecting the conditions of the calcination temperature of 900° C. or higher and 1600° C. or lower and the holding time at the calcination temperature of 2 hours or more and 24 hours or less, the ceria particles of the embodiment containing molybdenum can be easily obtained.

Calcination atmosphere is not particularly limited as long as an effect of the production method of the embodiment can be obtained, but for example, oxygen-containing atmosphere such as air or oxygen or an inert atmosphere such as nitrogen, argon or carbon dioxide is preferable, and air atmosphere is more preferable when considering the cost.

An apparatus for calcination is also not necessarily limited, and a so-called calcining furnace can be used. The calcining furnace is preferably made of a material that does not react with sublimated molybdenum oxide, and it is preferable to use a highly airtight calcining furnace so that the molybdenum oxide can be used efficiently.

### [Molybdenum Removal Step]

The production method of the embodiment may further include a molybdenum removal step of removing at least a part of molybdenum after the calcination step, if necessary.

As described above, since the molybdenum is sublimated during calcination, it is possible to control the molybdenum content present in the surface layer of the ceria particles, and to control the molybdenum content and its existence state in other than the surface layer (inner layer) of the ceria particles, by controlling the calcination time, the calcination temperature, and the like.

The molybdenum can adhere to the surface of the ceria particles. As a means other than the above sublimation, the molybdenum can be removed by washing with water, an aqueous ammonia solution, an aqueous sodium hydroxide solution or the like.

At this time, the molybdenum content in the ceria particles can be controlled by appropriately changing concentration and used amount of the water, the aqueous ammonia solution, or the aqueous sodium hydroxide solution used, and a washing site, a washing time or the like.

### [Pulverizing Step]

In a calcined product obtained through the calcination step, the ceria particles may aggregate, and the calcined product may not meet a range of particle diameter suitable for applications to be considered. Therefore, the ceria particles may be pulverized to satisfy the range of suitable particle diameter, if necessary.

A method for pulverizing the calcined product is not particularly limited, and conventionally known pulverizing methods such as ball mill, jaw crusher, jet mill, disc mill, Spectromill, grinder, and mixer mill can be used.

### [Classification Step]

The calcined product containing the ceria particles obtained in the calcination step may be appropriately classified in order to adjust a range of the particle size. A “classification process” refers to an operation of grouping particles based on the size of the particles.

The classification may be either wet or dry, but from a viewpoint of productivity, the dry classification is preferable. The dry classification includes classification by sieving, wind classification by a difference between centrifugal force and fluid drag, and the like, but from a viewpoint of classification accuracy, the wind classification is preferable, and can be performed by using a classifier using Coanda effect, such as an airflow classifier, a swirling airflow classifier, a forced vortex centrifugal classifier, and a semi-free vortex centrifugal classifier.

The above-mentioned pulverizing step and classification step can be performed at a necessary stage. For example, the average particle diameter of the ceria particles to be obtained can be adjusted by the presence or absence of pulverizing and classification, and selection of their conditions.

In the ceria particles of the embodiment or the ceria particles obtained by the production method of the embodiment, the ceria particles having little or no aggregation are likely to exhibit their original properties and are superior in their own handleability, and when they are used by being dispersed in a medium to be dispersed, they are preferable from the viewpoint of being more excellent in dispersibility.

Note that according to the production method of the above-described embodiment, since the ceria particles having little or no aggregation can be easily produced, it has an excellent advantage that the ceria particles having excellent desired properties can be produced with high productivity without performing the above-mentioned pulverizing step or classification step.

Since the ceria particles of the embodiment or the ceria particles obtained by the production method of the embodiment have the above-mentioned characteristics, they are suitably used, for example, for an abrasive, a three-way catalyst, a solid electrolyte, or the like.

### EXAMPLES

Next, the present invention will be described in more detail with reference to Examples, but the present invention is not limited to the following Examples.

### <Production of Ceria Particles>

### Comparative Example 1

3.0 g of cerium oxide (produced by Aladdin) was placed in a crucible and calcined in a ceramic electric furnace at 1100° C. for 24 hours. After the temperature was lowered, the crucible was taken out to obtain 3.0 g of gray powders.

### Comparative Example 2

Cerium oxide (produced by Aladdin) was used as it was as a sample of Comparative Example 2.

### Example 1

3.0 g of cerium oxide (produced by Aladdin), 2.71 g of molybdenum trioxide (produced by Chengdu Hongbo Industrial Co., Ltd.), 1.3 g of potassium carbonate, and 0.015 g of yttrium oxide were mixed in a mortar to obtain a mixture. The obtained mixture was placed in the crucible and calcined in the ceramic electric furnace at 1300° C. for 24 hours. After the temperature was lowered, the crucible was taken out to obtain 5.2 g of pale yellow powders. Subsequently, 5.2 g of the obtained pale yellow powders were suspended in 30 g of ion-exchanged water, stirred for two hours, filtered and washed to obtain 2.9 g of pale yellow powders.

### Example 2

3.0 g of cerium oxide (produced by Aladdin) and 3.0 g of sodium molybdate dihydrate (produced by Chengdu Hongbo Industrial Co., Ltd.) were mixed in the mortar to obtain the mixture. The obtained mixture was placed in the crucible and calcined in the ceramic electric furnace at 1300° C. for 24 hours. After the temperature was lowered, the crucible was taken out to obtain 4.6 g of light pink powders. Subsequently, 4.6 g of the obtained light pink powders were suspended in 30 g of ion-exchanged water, stirred for two hours, filtered and washed to obtain 2.8 g of light pink powders.

### <Evaluation>

The powders obtained in Examples 1 and 2 and Comparative Examples 1 and 2 were used as sample powders and evaluated as follows.

### [Measurement of Crystallite Diameter]

Using an X-ray diffractometer (SmartLab manufactured by Rigaku Corporation) equipped with a high-intensity high-resolution crystal analyzer (CALSA) as a detector, the measurement was performed by powder X-ray diffraction (2θ/θ method) under the following measurement conditions. Analysis was performed using CALSA function of analysis software (PDXL) manufactured by Rigaku Corporation, the crystallite diameter of the [111] plane was calculated using the Scherrer equation from the half width of the peak appearing near 2θ=28.5°, and the crystallite diameter of the [220] plane was calculated using the Scherrer equation from the half width of the peak appearing near 2θ=47.5°. Results are shown in Table 1.

### (Measurement Conditions of Powder X-Ray Diffraction Method)

Tube voltage: 45 kV
Tube current: 200 μmA
Scan speed: 0.05°/min
Scan range: from 10° to 70°
Step: 0.002°
βs: 20 rpm

Apparatus standard width: 0.026° calculated using standard silicon powder (NIST, 640d) produced by the National Institute of Standards and Technology was used.

### [Crystal Structure Analysis: X-Ray Diffraction (XRD) Method]

The sample powders were filled in a holder for a measurement sample having a depth of 0.5 mm, set in a wide-angle X-ray diffraction (XRD) apparatus (Ultima IV manufactured by Rigaku Corporation), and the measurement was performed under conditions of Cu/Kα ray, 40 kV/40 μmA, scanning speed 2°/min, and scanning range of 100 to 70°.

### [Measurement of Particle Size Distribution]

Using a laser diffraction type dry particle size distribution meter (HELOS (H3355) & RODOS manufactured by Japan Laser Corporation), the particle size distribution of the sample powders was measured by the dry method under conditions of a dispersion pressure of 3 bar and a pulling pressure of 90 μmbar. The particle diameter at a point where a distribution curve of cumulative volume % intersects a horizontal axis of 10% from the small particle side was defined as D₁₀, the particle diameter at a point where the distribution curve intersects the horizontal axis of 50% was defined as D₅₀, and the particle diameter at a point where the distribution curve intersects the horizontal axis of 90% from the small particle side was defined as D₉₀, and they were determined.

### [X-Ray Fluorescence (XRF) Analysis]

Using a fluorescent X-ray analyzer Primus IV (manufactured by Rigaku Corporation), about 70 μmg of the sample powders were placed on a filter paper, were covered with a PP film, and the X-ray fluorescence (XRF) analysis was performed under the following conditions.

### (Measurement Conditions)

EZ scan mode
Elements to be measured: F to U
Measurement time: standard
Measurement diameter: 10 μmm
Residual (Balance component): None

The results of the CeO₂ content (C₁) with respect to 100 mass % of the ceria particles and the MoO₃ content (M₁) with respect to 100 mass % of the ceria particles were obtained by XRF analysis.

### [XPS Surface Analysis]

For surface element analysis of the sample powders, X-ray Photoelectron spectroscopy (XPS) measurement was performed using QUANTERA SXM manufactured by ULVAC-PHI, Inc. and monochromatic Al—Kα as an X-ray source. In an area measurement of 1000 μm square, an average value of n=3 measurement was obtained in atom % for each element.

By converting the cerium content in the surface layer and the molybdenum content in the surface layer of the ceria particles obtained by xPS analysis into oxides, the CeC₂ content (C₂) (mass %) with respect to 100 mass % of the surface layer of the ceria particles and the MoO₃ content (M₂) (mass) with respect to 100 mass % of the surface layer of the ceria particles were determined.

### <Results>

Table 1 shows each value obtained by the above evaluation. Note that “N.D.” is an abbreviation for not detected, and indicates that it is not detected.

TABLE 1

| | | | | Comparative | Comparative | | |
|---|---|---|---|---|---|---|---|
| | | | | Example 1 | Example 2 | Example 1 | Example 2 |
| Production | | CeO₂ | g | 3.00 | — | 3.00 | 3.00 |
| Conditions | | MoO₃ | g | — | | 2.71 | — |
| | | Na₂MoO₄•2H₂O | g | — | | — | 3.00 |
| | | K₂CO₃ | g | — | | 1.30 | — |
| | | Y₂O₃ | g | — | | 0.015 | — |
| | | Mo/Ce | molar | — | | 1.08 | 0.71 |
| | | | ratio | | | | |
| | | Calcination | ° C. | 1100 | | 1300 | 1300 |
| | | temperature | | | | | |
| | | Calcination | hour | 24 | | 24 | 24 |
| | | time | | | | | |
| Evaluation | Particle | D10 | μm | 1.51 | 0.92 | 2.20 | 8.64 |
| | size | D50 | μm | 4.32 | 4.00 | 12.58 | 21.45 |
| | distribution | D90 | μm | 8.26 | 8.59 | 21.91 | 35.94 |
| | Crystallite | [111] plane | nm | 322 | 51 | 270 | 269 |
| | diameter | 28.5° | | | | | |
| | | [220] plane | nm | 409 | 45 | 332 | 431 |
| | | 47.5° | | | | | |
| | XRF | CeO₂ (C₁) | mass % | 99.40 | 99.80 | 93.10 | 98.70 |
| | | MoO₃ (M₁) | mass % | 0.07 | N.D. | 2.13 | 0.05 |
| | XPS | CeO₂ (C₂) | mass % | 91.40 | 100.00 | 11.50 | 63.60 |
| | | MoO₃ (M₂) | mass % | N.D. | N.D. | 59.40 | 21.10 |

| | | | | |
|---|---|---|---|---|
| MoO₃ surface layer | — | — | 27.89 | 398.11 |
| uneven distribution ratio | | | | |
| (M₂/M₁) | | | | |

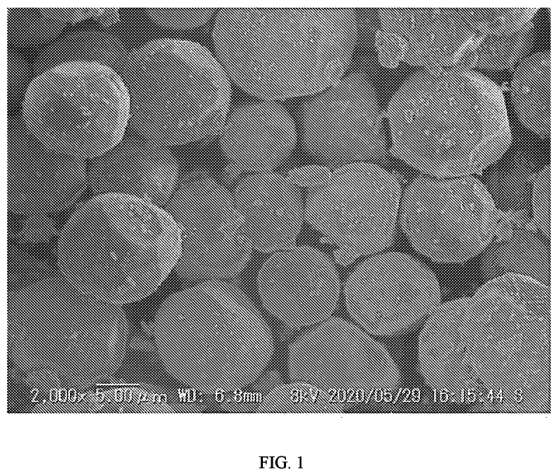

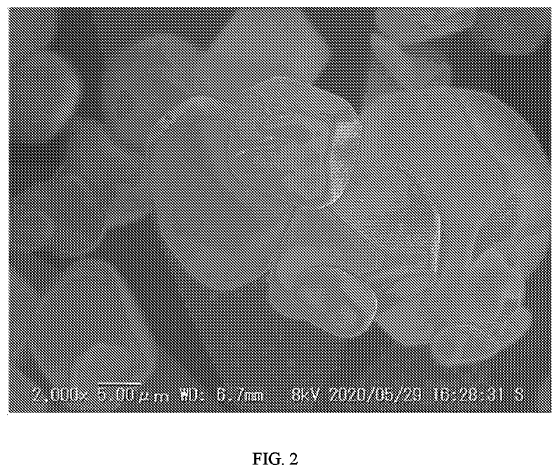

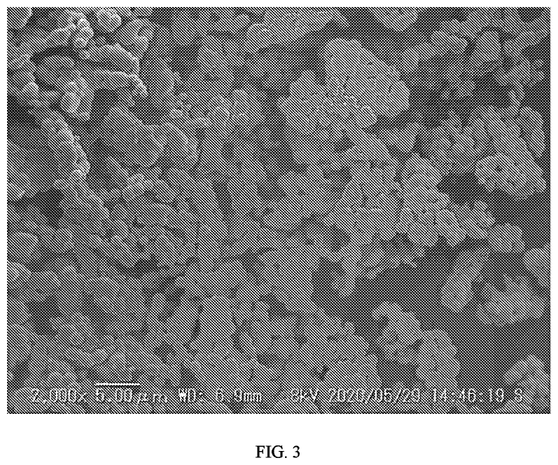

SEM images of the powders of the above Examples and Comparative Examples obtained by photographing with a scanning electron microscope (SEM) are shown in FIGS. 1 to 3. Granular or polyhedral particles were observed in each of Examples and Comparative Examples.

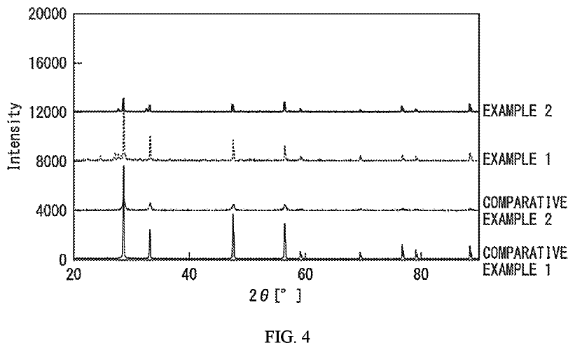

Results of XRD analysis are shown in FIG. 4. Each peak derived from the ceria (CeO₂) was observed in each sample of Examples and Comparative Examples.

From the results of the above SEM observation and XRD analysis, it was confirmed that the powders obtained in Examples and Comparative Examples were the ceria particles containing ceria.

According to comparison of Examples 1 and 2, when sodium molybdate dihydrate was used as the flux agent, since a crystal growth plane was larger and a growth rate was faster, the particles having a larger particle size (each value of D₁₀, D₅₀, and D₉₀) and larger crystallite diameter ([111] plane and [220] plane) tend to be obtained. Therefore, it was shown that the particle size of the ceria particles to be produced can be easily controlled by calcining the cerium compound in the presence of the molybdenum compound.

Further, as shown in Table 1, from the results of the MoO₃ content (M₁) and the MoO₃ content (M₂), the ceria particles of Examples 1 and 2 contain molybdenum on the surface, and it is expected that various actions of molybdenum, such as catalytic activity will be exerted.

Further, as shown in Table 1, from the results of the surface layer uneven distribution ratio (M₂/M₁) of the MoO₃ content (M₂) to the MoO₃ content (M₁), in the ceria particles of Examples 1 and 2, the molybdenum oxide content in the surface layer of the ceria particles determined by XPS surface analysis is greater than the molybdenum oxide content determined by XRF analysis. Therefore, it was confirmed that molybdenum was unevenly distributed in the surface layer of the ceria particles, and it can be expected that various actions of molybdenum will be effectively exerted.

Each configuration in each embodiment, a combination thereof, and the like are examples, and the configuration can be added, omitted, replaced, and other changes can be made without departing from the spirit of the present invention. Further, the present invention is not limited by each embodiment, but is limited only by the scope of the claims.

### INDUSTRIAL APPLICABILITY

According to the ceria particles and the method for producing the ceria particles of the embodiment, the ceria particles having a controlled particle diameter and particle size distribution can be obtained.

1. Ceria particles, comprising molybdenum.

2. The ceria particles according to claim 1, wherein the molybdenum is unevenly distributed in a surface layer of the ceria particles.

3. The ceria particles according to claim 1, wherein a crystallite diameter of a [100] plane of the ceria particles is 250 nm or more.

4. The ceria particles according to claim 1, wherein a crystallite diameter of a [101] plane of the ceria particles is 300 nm or more.

5. The ceria particles according to claim 1, wherein a median diameter D₅₀ of the ceria particles calculated by a laser diffraction/scattering method is 5.00 μm or more and 1000.00 μm or less.

6. The ceria particles according to claim 1, wherein
CeO₂ content C₁ with respect to 100 mass % of the ceria particles determined by XRF analysis of the ceria particles is 60.00 mass % or more and 99.30 mass % or less, and
MoO₃ content M₁ with respect to 100 mass % of the ceria particles determined by XRF analysis of the ceria particles is 0.05 mass % or more and 40.00 mass % or less.

7. The ceria particles according to claim 1, wherein
CeO₂ content C₂ with respect to 100 mass % of a surface layer of the ceria particles determined by XPS surface analysis of the ceria particles is 10.00 mass % or more and 90.00 mass % or less, and
MoO₃ content M₂ with respect to 100 mass % of the surface layer of the ceria particles determined by XPS surface analysis of the ceria particles is 2.00 mass % or more and 70.00 mass % or less.

8. The ceria particles according to claim 1, wherein a surface layer uneven distribution ratio M₂/M₁ of MoO₃ content M₂ with respect to 100 mass % of a surface layer of the ceria particles determined by XPS surface analysis of the ceria particles to MoO₃ content M₁ with respect to 100 mass % of the ceria particles determined by XRF analysis of the ceria particles is 0.05 or more and 1400.00 or less.

9. A method for producing the ceria particles according to claim 1, comprising calcining a cerium compound in presence of a molybdenum compound.

10. The method for producing the ceria particles according to claim 9, wherein the molybdenum compound is at least one compound selected from a group including molybdenum trioxide, lithium molybdate, potassium molybdate and sodium molybdate.

11. The method for producing the ceria particles according to claim 9, wherein a calcination temperature is 800° C. or higher and 1600° C. or lower.
